(19) United States
(12) Patent Application Publication
(10) Pub. No.: US 2020/0301027 A9
(43) Pub. Date: Sep. 24, 2020

(54) MATERIALS FOR IONIZING RADIATION DETECTION

(71) Applicant: Massachusetts Institute of Technology, Cambridge, MA (US)

(72) Inventors: Timothy M. Swager, Newton, MA (US); Maggie He, Cambridge, MA (US); Lukas Zeininger, Berlin (DE)

(73) Assignee: Massachusetts Institute of Technology, Cambridge, MA (US)

(21) Appl. No.: 16/358,340

(22) Filed: Mar. 19, 2019

Related U.S. Application Data
(60) Provisional application No. 62/644,842, filed on Mar. 19, 2018.

(51) Int. Cl. G01T 1/04; G01T 1/142; C08L 81/06; C08K 3/08; C08K 3/04; C01B 32/174

(52) U.S. Cl. CPC G01T 1/04; G01T 1/142; C08L 81/06; B82Y 30/00; C08K 3/041; C01B 32/174; C08K 3/042; C08K 3/08

(57) ABSTRACT

Compositions, devices, and methods for determining ionizing radiation are generally described.

### RELATED APPLICATIONS

This application claims the benefit of priority under 35 U.S.C. § 119(e) of U.S. Provisional Application No. 62/644,842, filed Mar. 19, 2018, entitled “MATERIALS FOR IONIZING RADIATION DETECTION,” the disclosure of which is incorporated by reference in its entirety.

### GOVERNMENT SUPPORT

This invention was made with Government support under Grant No. R41 ES027389 awarded by the National Institutes of Health (NIH). The Government has certain rights in the invention.

### TECHNICAL FIELD

Compositions, devices, and methods for determining ionizing radiation are generally described.

### BACKGROUND

Gamma ray sensors capable of reliably, sensitively, and quantitatively converting an adsorption of radioactive ionizing radiation into a measurable (physical) signal represent a crucial technology in many fields including medical radiation therapy, applied physics, industrial imaging, food and medical sterilization, and nuclear security. When designing a gamma ray sensor, the key properties of consideration are the determination of a durable and reliable transduction material that (i) exhibits good sensitivity for gamma rays, (ii) demonstrates environmental stability over the desired device lifetime without premature degradation, (iii) meets the requirements of the chosen application, such as a potential to operate at room temperature, (iv) can be produced with low synthetic/fabrication effort and operated with low maintenance cost, and (v) is ideally capable of creating a real-time signal. Ionization chambers are an example of sensitive gamma ray dosimeters, however, their applications are limited because of their large size and high bias voltage requirements for achievement of acceptable ionization collection efficiencies. Similarly, other technologies are often cumbersome and/or costly to use and fabricate, require operation at low temperatures, or are unable to create a real-time signal.

Molecular and nanoscale material-based radiation sensors can exhibit properties for radiation sensor applications to overcome these obstacles. Polymeric materials that rapidly depolymerize into volatile components on command are attractive for many applications, including smart-packaging, encapsulation, drug delivery, transient electronics, and wearable or free standing sensor applications. Examples of these types of self-immolating polymers are poly(olefin sulfone)s (POSs). POSs exhibit low ceiling temperatures and have been shown to undergo triggered depolymerization when exposed to heat, base, or ionizing radiation. POSs possess mainchain sulfonyl (SO₂) groups and can be synthesized by low temperature free radical polymerization of olefin monomers in liquefied sulfur dioxide. As a result, their characteristics have been targeted for the development of photoresists and other degradable materials. The generation of radicals, abstraction of acidic protons, or the removal of an electron from the polymer backbone can lead to polymer chain scission. Therefore, one triggering event can cause the whole polymer to decompose.

To translate POS materials to sensor applications triggered by depolymerization, a measurable modification, amplification, or reduction of a detectable signal must be generated. Therefore, as is also typical for chemical sensors, a sensory material that selectively responds to a target event needs to be connected to an efficient physicochemical transducer to give a readable, and ideally real-time, signal. Nanostructures are exceptional transduction materials and have found utility in a variety of chemical sensor applications. For example, a nanostructure network is placed between two electrodes with a static potential bias (V), and the resulting output current (I) changes with the resistance (R) of the active layer according to Ohm's Law. In impedance or capacitive devices, measurable changes of the dielectric constant resulting from new lower resistance contacts between conductive nanostructures can potentially lead to increased sensitivity of the sensor device. Advantages of nanostructure-based nanowire resistive sensors include straightforward signal detection, low power consumption, ease of miniaturization, and sensitivity, which combine to facilitate real-time detection.

The introduction of new polymer matrices capable of programmed degradation upon high-energy irradiation, along with innovations in the fabrication of polymer-nanostructure composites offers an appealing strategy to enable real-time dosimetric electrical detection of gamma irradiation. Nanostructure materials are readily integrated into small devices, are low cost, and have similar opacity to biological tissue, all of which are desirable for gamma ray dosimeters. Accordingly, improvements are needed.

### SUMMARY

Compositions, devices, and methods for determining ionizing radiation are generally described. The subject matter of the present invention involved, in some cases, interrelated products, alternative solutions to a particular problem, and/or a plurality of different uses of one or more systems and/or articles.

According to certain embodiments, a composition comprises a plurality of functionalized single-walled nanostructures, and a polymer material integrally connected to at least a portion of the functionalized single-walled nanostructures, wherein at least a portion of the polymer material undergoes a change in polymerization characteristic upon exposure of the device to radiation.

In certain embodiments, a device for determining ionizing radiation comprises a sensor material comprising a plurality of functionalized single-walled nanostructures and a polymer material integrally connected to at least a portion of the functionalized single-walled nanostructures, wherein at least a portion of the polymer material undergoes a change in polymerization characteristic upon exposure of the device to radiation, and a signal generator that generates a signal response to a change in polymerization characteristic, indicative of ionizing radiation.

Certain embodiments are related to a composition for determining ionizing radiation, comprising a plurality of nanostructures and a polymer material integrally connected to at least a portion of the nanostructures, wherein the polymer material comprises a poly(olefin sulfone) comprising the structure,

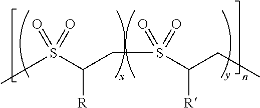

wherein R and R′ can be the same or different and are alkyl, heteroalkyl, alkenyl, heteroalkenyl, alkynyl, heteroalkynyl, aryl, heteroaryl, any of which may be substituted; and x, y, and n is 1 or greater.

Certain embodiments are related to a method for determining ionizing radiation, comprising exposing a device comprising a sensor material comprising a plurality of functionalized single-walled nanostructures and a polymer material integrally connected to at least a portion of the plurality of functionalized single-walled nanostructures to an environment suspected of containing ionizing radiation, wherein the ionizing radiation, if present, interacts with the polymer material such that at least a portion of the polymer material undergoes a change in polymerization characteristic, thereby generating a determinable signal, and determining the signal.

In certain embodiments, a method for determining ionizing radiation is described, comprising exposing a device comprising a sensor material comprising a plurality of nanostructures and a polymer material integrally connected to at least a portion of the plurality of nanostructures to an environment suspected of containing ionizing radiation, wherein the ionizing radiation, if present, interacts with the polymer material such that at least a portion of the polymer material undergoes a change in polymerization characteristic, thereby generating a determinable signal, and determining the signal, wherein the determinable signal comprises at least a 10% decrease in resistance upon exposure to no more than a 40 krad dose of radiation.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows, according to certain embodiments, an illustration of the dispersion of single-walled nanotubes (SWNTs) by wrapping with poly(olefin sulfone) chains and how gamma ray initiated depolymerization of the POS can create resistive or capacitive responses;

FIG. 2 shows, according to some embodiments, the synthesis and structures of poly(olefin sulfones)s;

FIG. 3 shows, according to certain embodiments, four wrapping approaches for SWNT with poly(olefin sulfone) chains;

FIG. 4A shows, according to certain embodiments, UV-vis-NIR spectra of selected poly(olefin sulfone)-SWNT dispersions (wavelength vs. absorption);

FIG. 4B shows, according to certain embodiments, UV-vis-NIR spectra of selected poly(olefin sulfone)-SWNT dispersions (wavelength vs. normalized absorbance);

FIG. 5A shows, in accordance with certain embodiments, real-time resistance changes of selected poly(olefin sulfone)-SWNT composites to gamma ray radiation;

FIG. 5B shows, according to certain embodiments, sensitivity to gamma rays of SWNT-POS composites as a function of the dispersion efficiency;

FIG. 6A shows, according to certain embodiments, wrapping of bismuth-nanoparticles with an amphiphilic poly(olefin sulfone);

FIG. 6B shows, in certain embodiments, dynamic light scatting curves demonstrating the stabilization of bismuth-nanoparticles in poly solution with an amphiphilic poly(olefin sulfone);

FIG. 6C shows, according to certain embodiments, device performance before and after addition of amphiphilic poly(olefin sulfone) coated bismuth-nanoparticles to a composition of poly(olefin sulfone) and SWNTs;

FIG. 7A shows, according to some embodiments, an image of a capacitive device;

FIG. 7B shows, in accordance with certain embodiments, a schematic of an electric circuit;

FIG. 7C shows, according to certain embodiments, real-time performance of selected poly(olefin sulfone)-SWNT composites to gamma radiation in the capacitive devices; and

FIG. 8 shows, examples of cationic complexes useful in chemically amplified lithography.

### DETAILED DESCRIPTION

The present invention generally provides compositions and devices capable of interacting with ionizing radiation (e.g., gamma rays, neutrons) to produce an observable signal from the device, and related methods. In some cases, methods for in situ and/or real-time detection of ionizing radiation are provided.

The embodiments described herein may be useful in the determination, characterization, and/or dosimetry of at least one type of ionizing radiation. In some cases, the compositions and/or devices may exhibit high sensitivity to ionizing radiation and may be used to distinguish between various types of radiation. Some embodiments may also provide simplified, less bulky sensor devices that may advantageously be operated at ambient temperature and/or without need for high voltages associated with other types of radiation detectors. Devices and methods described herein may provide an inexpensive, modular real-time radiation sensor platform having applications for energy, national security, biological and nuclear research, sterilization conformation, wearable dosimeters, as well as other advanced applications such as monitoring the attrition of materials in space.

In some cases, ionizing radiation may be determined by monitoring, for example, a change in a signal of a material (e.g., sensor material) present within the device, upon exposure to ionizing radiation. In some cases, the change in signal may be associated with an interaction between the device and the radiation, a chemical reaction within the device, or a change in polymerization state of a component of the device. The signal may comprise an electrical, optical, mechanical, or other property of the device, as described further below. For example, the method may involve use of a component having a resistance, where the resistance of the component is affected by (e.g., responsive to) ionizing radiation. The signal can be read-out by a low power and low current circuit, without need for a bulky apparatus, like in the case of a Geiger counter. In certain embodiments, the capacitance of a component is affected by ionizing radiation, where the change in capacitance may be determined without the need for a complete circuit. In some embodiments, the signal generator generates a change in capacitance. The method, in some aspects, may involve use of a component having a spectral change (e.g., a visible change), where the spectral change is affected by ionizing radiation.

Some embodiments of the invention may also provide devices for determination of ionizing radiation and its energy. As used herein, “ionizing radiation” is given its ordinary meaning in the art and refers to nuclei, subatomic particles, and/or electromagnetic waves having sufficient energy to ionize an atom or molecule. Various types of ionizing radiation exist, including ultraviolet rays, X-rays, gamma rays, alpha particles, beta particles, neutrons, and electrons. The device, or portion thereof, may interact with ionizing radiation such that a chemical event (e.g., chemical reaction, change in polymerization state) occurs, giving rise to a determinable signal, or change in signal. In some cases, a single chemical event within the device may trigger a cascade of events, which may produce an amplified response to ionizing radiation.

In some embodiments, the device includes a sensor material that may be affected by interaction with ionizing radiation, generating a determinable signal. In certain embodiments, the device comprises a sensor material that is responsive to one or more types of ionizing radiation. The sensor material, in some aspects, comprises a material that is capable of undergoing a change in one or more properties upon exposure to ionizing radiation. For example, the sensor material may include a conductive, semiconductive, or semimetallic material having electrical properties that may be affected by the presence of ionizing radiation. In some cases, the sensor material includes a luminescent material having optical properties that may be affected by changes in the material resulting from ionizing radiation. In some embodiments, the sensor material includes a material capable of undergoing a volumetric or dimensional change upon exposure to ionizing radiation. In certain embodiments, the sensor produces volatile components after exposure to ionizing radiation, which change the properties of the materials in the sensor. In some embodiments, the sensor generates Brønsted acids after exposure to ionizing radiation. The devices described herein may be designed and fabricated to determine one or more types of ionizing radiation. In some embodiments, for example, the device is designed and fabricated to determine gamma rays, neutrons, other types of radiation, or a combination thereof.

In some embodiments, the sensor material may comprise a conductive, semiconductive, semimetallic species, or other species capable of transporting charge to create a conductive pathway. The conductive, semiconductive, or semimetallic species may include inorganic materials (e.g., metals, alloys, semiconductors), organic materials (e.g., polymer materials), organometallic materials, carbon nanomaterials, and/or combinations thereof.

In some cases, the sensor material may include a plurality of nanostructures (e.g., nanotubes, nanowires, nanoribbons, nanoparticles, etc.). The nanostructures may be selected to exhibit, for example, high charge mobilities and/or resistance to damage from ionizing radiation. In some cases, mixtures or assemblies of nanostructures may be utilized. Some embodiments may involve the use of single-walled nanostructures.

Certain embodiments may involve the use of carbon nanotubes, such as single-walled carbon nanotubes (SWCNTs), which can display relatively high charge mobilities (e.g., 100,000 cm²/Vs for SWCNTs). In some cases, nanowires, such as gold, silver, copper, bismuth, gadolinium nanowires, may be used as the conductive species. In some aspects, the conductive, semiconductive, or semimetallic species may comprise nanoparticles (e.g., bismuth nanoparticles).

Certain embodiments herein are related to a composition. According to certain embodiments, the composition comprises a plurality of functionalized single-walled nanostructures (SWNSs). In certain embodiments, the plurality of functionalized nanostructures comprise functionalized SWNTs, such as single-walled carbon-nanotubes (SWNCTs). According to some embodiments, the plurality of functionalized single-walled nanostructures comprise graphene. In certain embodiments, the functionalization of the plurality of nanostructures is designed to create enhanced interactions with the polymer material, as described further herein.

In some cases, the plurality of functionalized single-walled nanostructures are covalently functionalized. For example, in some embodiments, the plurality of single-walled nanostructures are covalently functionalized with Lewis or Brønsted basic moieties. According to certain embodiments, the functionalization of the single-walled nanostructures is designed to interact with Brønsted acidic groups that are capable of proton transfer or hydrogen bonding. In some embodiments, the plurality of single-walled nanostructures are covalently functionalized with nitrogen-containing heterocycles. In certain embodiments, the plurality of single-walled nanostructures are covalently functionalized with pyridyl moieties. In certain embodiments, the plurality of single-walled nanostructures are functionalized using carbon-carbon bonds. In some embodiments, the plurality of single-walled nanostructures are functionalized using carbon-nitrogen bonds. According to certain embodiments, examples of nitrogen-containing heterocycles attached to a plurality of single-walled nanostructures through carbon-carbon bonds include:

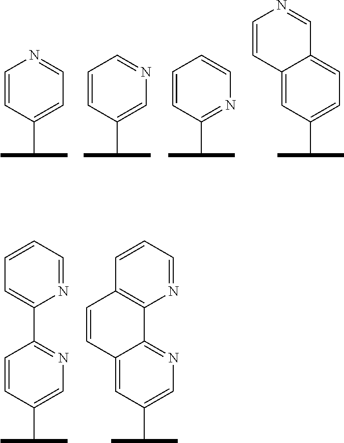

In some embodiments, examples of nitrogen-containing heterocycles attached to a plurality of single-walled nanostructures through carbon-nitrogen bonds include:

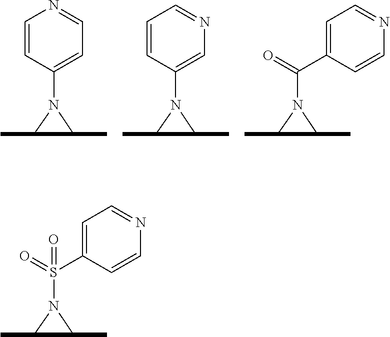

According to certain embodiments, the plurality of functionalized single-walled nanostructures are non-covalently functionalized. For example, according to certain embodiments, the single-walled nanostructures are functionalized using noncovalent bonds. In certain embodiments, pyridine or other basic functionalization can be installed by non-covalent attachment by absorbing to the surface of the plurality of nanostructures. According to some embodiments, the polymer material contains basic heterocycles. For example, according to certain embodiments, polymer materials comprising basic heterocycles include poly(4-vinylpyridine). In other cases, the plurality of single-walled nanostructures can be functionalized with polymers that respond to acid generated by radiation exposure and include the following examples:

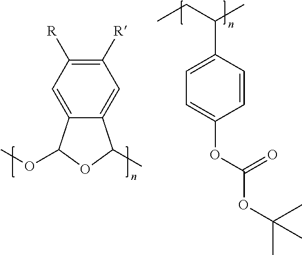

In some embodiments, the nanostructures are positioned relative to one another in the device at a distance, so as to together define an average distance between adjacent nanostructures. In operation, ionizing radiation may affect the sensor material such that the average distance between adjacent nanostructures is altered (e.g., increased, decreased), indicating the presence and/or amount of ionizing radiation. For example, the distance between adjacent nanostructures may decrease, such that the nanostructures that have high charge mobility and/or high radiation damage threshold aggregate to form a circuit. Such changes in the electrochemical state, resistive state, or capacitive state of the nanostructures may be used to indicate the presence of ionizing radiation.

Changes in the relative position of nanostructures in the device may be achieved by, for example, arranging the nanostructures in combination with (e.g., dispersed within) a matrix responsive to ionizing radiation. For example, the sensor material may comprise a polymer material, where at least a portion of the polymer material may undergo a change in a polymerization characteristic upon exposure of the device to ionizing radiation. The change in polymerization characteristic may be, for example, a change in the degree of polymerization (e.g., increased polymerization, depolymerization, etc.), morphology, chemical structure, emissive nature, color, modulus, or other property of the polymer material. In some cases, the ionizing radiation may interact with the polymer material such that a portion of the polymer undergoes degradation or depolymerization. As used herein, the term “depolymerization” is given its ordinary meaning in the art and refers to a process by which a macromolecule (e.g., a polymer) is converted (e.g., decomposed, cleaved) into smaller compounds by cleavage of at least one bond of the macromolecule. For example, a polymeric species may be depolymerized into its monomeric constituents via cleavage of one or more bonds of the polymer backbone. In some embodiments, chain scission caused by gamma rays, neutrons, or other forms of radiation can result in disassembly of polymer chains.

Some embodiments may involve the use of a polymer material that, upon exposure to ionizing radiation, generates at least one initiator species capable of causing a change in a polymerization characteristic of at least a portion of the sensor material. For example, depolymerization of a first polymer may generate a plurality of initiator species capable of effecting depolymerization of a second polymer, thereby producing an amplified response from the device. The first and second polymers may be the same type of polymer species or may be different polymers species (e.g., may have different chemical structures).

In one set of embodiments, the sensor material comprises a plurality of nanostructures and a polymer material integrally connected to at least a portion of the plurality of nanostructures. The term “integrally connected,” when referring to two or more objects, means objects that do not become separated from each other during the course of normal use, i.e., separation of the objects generally requires at least the use of tools, and/or by causing damage to at least one of the components, for example, by breaking, peeling, dissolving, etc. In some cases, the nanostructures are dispersed within the polymer material, such that individual nanostructures have minimal or substantially no physical contact with adjacent nanostructures.

In certain embodiments, the functionalization of the single-walled nanostructures is designed to create enhanced interactions with the polymer material. According to certain embodiments, the polymer material and the plurality of functionalized single-walled nanostructures are integrally connected by a covalent bond. In some cases, the covalent bond may be between the polymer material and the functionalized portion of the functionalized single-walled nanostructure (e.g., the enhanced interaction is covalent bonding). In certain embodiments, the polymer material and the plurality of functionalized single-walled nanostructures are integrally connected by a hydrogen bond. According to certain embodiments, the hydrogen bond may be between the polymer material and the functionalized portion of the functionalized single-walled nanostructure (e.g., the enhanced interaction is hydrogen bonding). In certain embodiments, the polymer material and the plurality of functionalized single-walled nanostructures are integrally connected by an electrostatic interaction. According to certain embodiments, the electrostatic interaction may be between the polymer material and the functionalized portion of the functionalized single-walled nanostructure (e.g., the enhanced interaction is an electrostatic interaction). In certain embodiments, the polymer material and the plurality of functionalized single-walled nanostructures are integrally connected by a non-covalent bond. In certain embodiments, the non-covalent bond may be between the polymer material and the functionalized portion of the functionalized single-walled nanostructure.

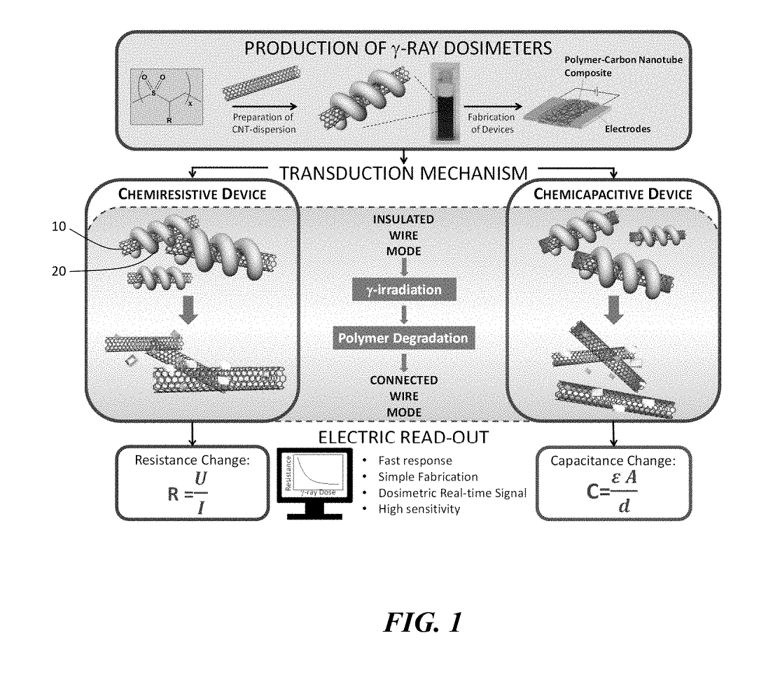

The device may further comprise a first electrode and a second electrode arranged in electrochemical communication with the sensor material, where current flow between the electrodes is affected by the sensor material. FIG. 1 shows an illustrative embodiment of a device, prior to exposure to ionizing radiation, where nanostructure 10 is insulated from an adjacent nanostructure by polymer material 20. That is, the nanostructures are dispersed within the polymer material, preventing optimal contact between the nanostructures and resulting in high resistance and low conductivity (e.g., no signal). The polymer material maintaining the nanojunctions between nanostructures serves as an insulating matrix that is thermally stable, but depolymerizes rapidly with a radiation induced chain scission event, thus placing the nanostructures at the cusp of a percolative threshold to forming a circuit between the two electrodes. Upon exposure to radiation, at least a portion of polymer material 20 may undergo depolymerization, resulting in aggregation of the nanostructures and producing a conductive network with decreased resistance and increased conductivity (e.g., signal generation). According to certain embodiments, the signal generator generates a change in resistivity. The increase in conductivity may be detected by amperometry (measurement over time of the current intensity, I, between two electrodes at a constant potential, V), or other methods. According to certain embodiments, the determinable signal comprises a decrease in resistance upon exposure to no more than a 40 krad dose of radiation. In certain embodiments, the decrease in resistance upon exposure to no more than a 40 krad dose of radiation may be any suitable decrease in resistance. For example, the determinable signal comprises at least a 10% decrease in resistance, at least a 20% decrease in resistance, at least a 30% decrease in resistance, at least a 40% decrease in resistance, at least a 50% decrease in resistance, at least a 60% decrease in resistance, at least a 50% decrease in resistance, at least an 80% decrease in resistance, or at least a 90% decrease in resistance upon exposure to no more than a 40 krad dose of radiation. In certain embodiments, the determinable signal comprises less than a 100% decrease in resistance, less than a 90% decrease in resistance, less than an 80% decrease in resistance, less than a 70% decrease in resistance, less than a 60% decrease in resistance, less than a 50% decrease in resistance, less than a 40% decrease in resistance, or less than a 30% decrease in resistance upon exposure to no more than a 40 krad dose of radiation. Combinations of these ranges are also possible (e.g., at least a 40% and less than an 80% decrease in resistance upon exposure to no more than a 40 krad dose of radiation). Other ranges are also possible.

The sensor material may comprise one or more additional components that may enhance the stability of the device and/or responsiveness of the device to ionizing radiation. In some cases, the sensor material includes at least one additive that facilitates interaction between the sensor material and ionizing radiation, improves sensitivity for a particular type of ionizing radiation, or otherwise enhances performance of the device. In some cases, the additive may associate with the sensor material such that it enhances an electrical, optical, or other property of the sensor material. The additive may be positioned within the sensor material such that interaction of the ionizing radiation with the additive causes, enhances, or otherwise facilitates a determinable change in signal upon exposure to an ionizing radiation. According to some embodiments, the determinable signal comprises a change in resistance and/or capacitance associated with a circuit including the first electrode and the second electrode. For example, a sensor material may comprise an additive positioned in sufficient proximity physically, or within sufficient electronic or inductive communication range, to one or more components of the device able to generate a signal. In some embodiments, the additive may be covalently attached to a component (e.g., polymer material) of the device, or may be dispersed within a component (e.g., sensor material) of the device. In some embodiments, the sensor material may comprise a plurality of additives.

The additive may be selected to enhance the sensitivity of the interaction between the ionizing radiation and the sensor material. For example, incorporation of a plurality of additives within the device may improve the interaction between the sensor material and the ionizing radiation, producing a large change in signal. In some cases, the additive (e.g., a metal-containing additive) may have high opacity to radiation, and may increase the cross-section value of the sensor material for interaction with ionizing radiation, such that a determinable signal may be observed. The additive may be also selected to enhance the selectivity of the interaction between the ionizing radiation and the sensor material. For example, additives may be selected such that the sensor material interacts with a particular type of ionizing radiation to a greater extent than others, or with more than one type of ionizing radiation. That is, the sensor material may comprise additives which distinguish between different forms of radiation (e.g., gamma rays, neutrons) present within a sample.

In some embodiments, the sensor material may comprise a metal-containing group, such as a metal complex or a metal nanoparticle. The metal-containing group may be selected to have a high opacity for one or more types of ionizing radiation. In some cases, the metal-containing group may have a high opacity for gamma rays. In some cases, the metal-containing group may have a high opacity for neutrons. For example, the metal may be selected to have a high atomic number, as the cross-section values for the interaction of gamma rays with different elements increases with increasing atomic number. In some embodiments, the metal-containing group comprises a heavy metal. Incorporation of such additives within the sensor material may increase the capture cross-section and sensitivity of the device for one or more types of ionizing radiation. In some embodiments, incorporation of an additive within the sensor material may increase the sensitivity of the device to ionizing radiation, or a specific type of radiation, by at least about 5%, at least about 10%, at least about 20%, at least about 40%, at least about 60%, at least about 80%, at least about 100%, at least about 200%, or greater.

In one set of embodiments, the metal-containing group comprises bismuth (Bi). Bismuth is the element with the highest atomic number element that does not have naturally abundant radioactive isotopes with short half-lives. In some cases, incorporating bismuth-containing species within the sensor material may increase the opacity (e.g., cross-section) of the sensor material towards radiation such as gamma rays. Bismuth may form stable compounds with direct bismuth-carbon bonds, and the metal centers may have relatively low coordination numbers. Species comprising triphenyl bismuth, Bi(Ph)₃, for example, can be readily synthesized. In some embodiments, a bismuth-containing species may be incorporated into polymer materials described herein using click chemistry, as described more fully below.

In another set of embodiments, the metal-containing group comprises gadolinium. Gadolinium (Gd) has the second highest cross-section for interaction with neutrons after 135Xe, and gadolinium-containing species have been utilized as a relaxation agent for creating contrast in MRI imaging. In some cases, incorporation of gadolinium-containing species within the polymer material may increase the opacity of the sensor material towards neutrons. Various gadolinium-containing species may be designed and synthesized using methods known in the art, including click chemistry.

Some embodiments may involve incorporation of metal nanoparticles within the sensor material. In some cases, nanoparticles of varying sizes may be incorporated into the device to create differential responses to different energy radiation. In some embodiments, the nanoparticle may have a maximum cross-sectional dimension between less than 1 micrometer and greater than or equal to about 1 nanometer. Nanoparticles may comprise inorganic or organic, polymeric, ceramic, semiconductor, metallic, non-metallic, magnetic, crystalline (e.g., “nanocrystals”), or amorphous material, or a combination of two or more of these. The nanoparticles may be also selected to be positively or negatively charged. Typically, nanoparticles may have a particle size less than 500 nm in any dimension, less than 250 nm in any dimension, less than 100 nm in any dimension, or less than 50 nm in any dimension. In some embodiments, the nanoparticles may have a diameter of about 2 to about 50 nm. In some embodiments, the nanoparticles may have a diameter of about 2 to about 20 nm. The particle size may be measure by methods known in the art, such as electron microscopy.

In certain non-limiting embodiments, metal microparticles may be incorporated into the device to create differential response to different energy radiation. In certain embodiments, for example, the microparticle may have a maximum cross-sectional dimension of about 1 μm (e.g., slightly more than 1 μm).

According to certain embodiments, the compositions and devices described herein comprise nanoparticles with high atomic numbers capable of increasing the opacity to ionizing radiation. In some embodiments, the compositions and devices comprise nanoparticles in addition to the plurality of nanostructures integrally connected to a polymer material. In certain embodiments, the nanoparticles comprise a non-radioactive element that is responsive to radiation (e.g., ionizing radiation). For example, according to certain embodiments, the nanoparticles comprise bismuth. In some embodiments, the nanoparticles comprise gadolinium. According to certain embodiments, the nanoparticles (e.g., bismuth nanoparticles), are functionalized with an organic material (e.g., an organic coating). The organic material may be sensitive to ionizing radiation. In certain embodiments, the organic material may increase the signal response of the device. According to certain embodiments, the nanoparticles have an intrinsic conductivity.

Additives for facilitating processing and/or improving stability of the device may also be incorporated into the sensor material. In some embodiments, the sensor material may include a species that can improve or enhance the compatibility (e.g., miscibility, solubility) of the various components of the sensor material. Such additives may be useful in the formation of stable nanostructure dispersions and/or films. For example, the sensor material may comprise a plurality of nanostructures, a polymer material in which the nanostructures are dispersed, and a species capable of associating with nanostructures (e.g., carbon nanotubes) to enhance the compatibility of the nanostructures with the polymer material. In some cases, the species may interact with the nanostructures via a bond, such as a covalent bond, an ionic bond, a hydrogen bond (e.g., between hydroxyl, amine, carboxyl, thiol and/or similar functional groups, for example), a dative bond (e.g. complexation or chelation between metal ions and monodentate or multidentate ligands), or the like. The interaction may also comprise Van der Waals interactions. In some cases, the interaction between the species and the nanostructure may comprise a non-covalent bond. In some embodiments, non-covalent interactions between the species and the nanostructures may be advantageous in that the electronic structure of the nanostructures may not be substantially affected (e.g., perturbed), and the high carrier mobility of the nanostructures may be maintained.

In some embodiments, the species may interact with the nanostructures via pi-pi-stacking interactions. Examples of such species include aromatic moieties, such as polycyclic aromatic hydrocarbons. In some embodiments, the sensor material comprises pyrene groups, which are known to interact with the surface of a carbon nanotube (e.g., by pi-pi stacking interactions). The aromatic moieties may be covalently bound to the polymer material, or may otherwise be associated with the polymer material.

In some embodiments, the additive can be used to change the conductivity of the nanostructure. For example, in the case of semiconductive nanostructures, the number of charge carriers can be changed. In some embodiments, if an additive becomes a stronger electron acceptor as a result of exposure to ionizing radiation, then more positive charge holes may be injected into the nanomaterial to increase its conductivity and/or capacitance. In certain embodiments, quinones are a class of materials that could be used in this regard in conjunction with acid generated by ionizing radiation.

In other embodiments, the additive can be an organic dye that changes its color or emission properties as a result of changes induced by exposure to radiation. For example, in certain embodiments, the additive may be a dye that has an electron donating portion and an electron withdrawing portion, and can be modified by reaction with a Brønsted acid. In certain embodiments, if the electron withdrawing section is protonated, the additive can become a stronger electron acceptor, shifting absorption and emission to longer wavelengths. It is also possible, in certain embodiments, to create changes through the electron donating portion of the additive. In certain embodiments, the following reaction will occur to give a strong change in absorption and emission, wherein “Ar” represents an aromatic ring structure. According to some embodiments, the product of the reaction will have a longer wavelength absorption and longer wavelength brighter emission.

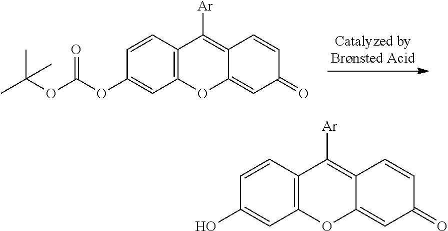

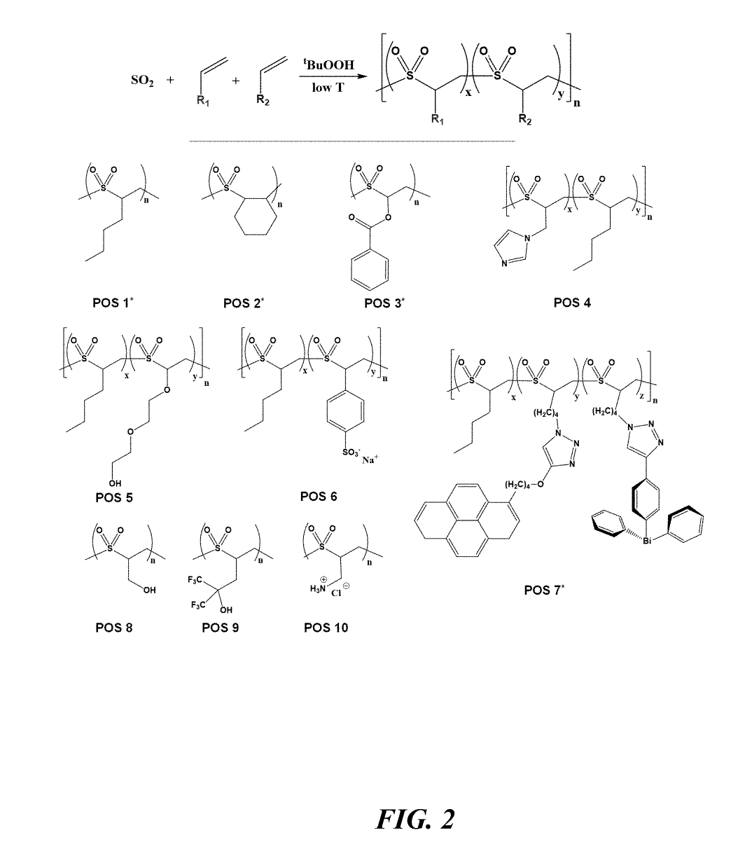

The polymer material may comprise any polymer having sensitivity to ionizing radiation, i.e., any polymer that undergoes a change in polymerization characteristic upon exposure to ionizing radiation. For example, the polymer species may be depolymerized to produce one or more volatile species that may be removed from the device (e.g., via evaporation). In one set of embodiments, the polymer material may comprise an optionally substituted poly(olefin sulfone) (POS), which may undergo chain-scission and depolymerization in the presence of ionizing radiation to produce sulfur dioxide and an olefin species. POSs have been used as electron beam resists and may degrade in the presence of ionizing radiation (e.g., high energy electrons, gamma rays). Such polymers may be synthesized via radical chain growth polymerization of sulfur dioxide (SO₂) and an olefin, as shown in FIG. 2. In some cases, conditions for the synthesis of POSs involves bulk polymerization at low temperatures with condensed liquid SO₂ as the solvent and t-butyl hydroperoxide as the initiator. Polymers obtained in this manner typically show a 1:1 ratio of perfectly alternating sulfone and olefin units when there is an alkyl moiety directly linked to the olefinic residue. Those of ordinary skill in the art would be able to select the appropriate monomer species and polymerization conditions suitable for use in a particular application. In some cases, olefins used for polymerization are electron-rich, sterically unhindered, non-basic, and/or is at least partially solubility in SO₂.

ΔG=ΔH−TΔS (Equation 1)

Thermodynamically, the polymerization to form POSs typically proceeds (negative ΔG in Eq. 1) at low temperature (T) due to the decrease in entropy, a negative ΔS term, in the polymerization process. At higher temperature, the polymerization may occur to a lesser degree, or not at all, since the −TΔS term in Eq. 1 causes the polymerization to be endothermic (positive ΔG). The POS structures are kinetically stable at ambient and even elevated temperatures because they are kinetically trapped by strong bonds at the terminus of the polymer chains. Since these bonds are not readily thermalized at temperatures of interest, the materials can have good shelf life and can be used over a range of conditions. However, once a chain is broken by a radiation induced event, the polymer rapidly depolymerizes into its monomeric components. That is, the diffusion of monomer may advantageously drive the depolymerization.

The following examples are intended to illustrate certain embodiments of the present invention, but do not exemplify the full scope of the invention.

In some embodiments, the sensor material comprises a polymer having the structure,

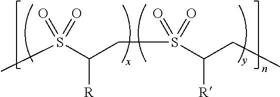

wherein R and R′ can be the same or different and are alkyl, heteroalkyl, alkenyl, heteroalkenyl, alkynyl, heteroalkynyl, aryl, heteroaryl, any of which may be substituted; and x, y, and n is 1 or greater.

According to certain embodiments, the sensor material comprises a polymer having the structure,

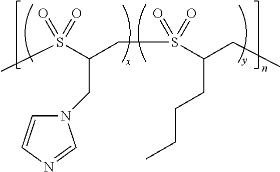

wherein x, y, and n is 1 or greater.

According to certain embodiments, the sensor material comprises a polymer having the structure,

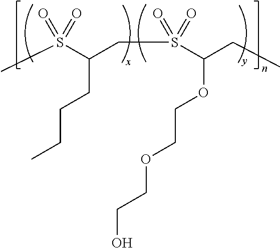

wherein x, y, and n is 1 or greater.

According to certain embodiments, the sensor material comprises a polymer having the structure,

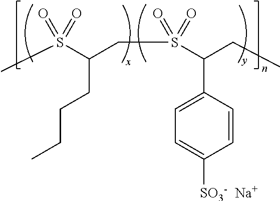

wherein x, y, and n is 1 or greater.

According to certain embodiments, the sensor material comprises a polymer having the structure,

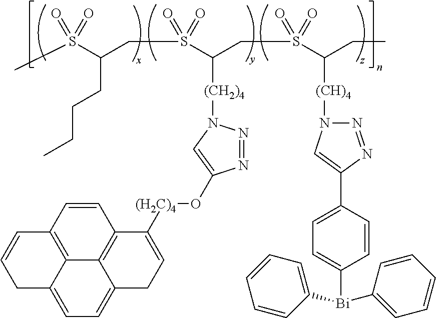

wherein x, y, and n is 1 or greater.

In some embodiments, the sensor material comprises a polymer having the structure,

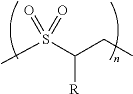

wherein R is alkyl, heteroalkyl, alkenyl, heteroalkenyl, alkynyl, heteroalkynyl, aryl, heteroaryl, any of which may be substituted; and n is 1 or greater.

According to certain embodiments, the sensor material comprises a polymer having the structure,

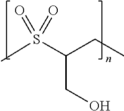

wherein n is 1 or greater.

According to certain embodiments, the sensor material comprises a polymer having the structure,

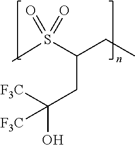

wherein n is 1 or greater.

According to certain embodiments, the sensor material comprises a polymer having the structure,

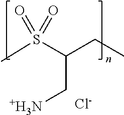

wherein n is 1 or greater.

In one set of embodiments, the sensor material may comprise a mixture of polymers, each polymer capable of undergoing a change in a polymerization characteristic upon exposure to ionizing radiation. In some cases, a multistage, cascade event may occur, where a change in a polymerization characteristic of a first polymer may cause a change in a polymerization characteristic of a second polymer. For example, the sensor material may comprise a first polymer and a second polymer, and exposure to ionizing radiation results in depolymerization of the first polymer to produce an initiator species, which may then interact with the second polymer to result in depolymerization of the second polymer.

Those of skill in the art would be able to identify other materials having complementary reactivity to perform such a cascade reaction. For example, the materials may be selected such that a first polymer is capable of producing a species that may catalyze depolymerization of a second polymer.

In another set of embodiments, the sensor material may comprise an additive that may interact with ionizing radiation to produce an initiator species. The initiator species may then interact with a polymer material, or portion thereof, to cause a change in a polymerization characteristic of the polymer material (e.g., depolymerization). For example, according to certain embodiments, exposure to ionizing radiation produces an acid (e.g., a solution acidity) that causes additional changes in the composition and/or sensor material of the device. In some embodiments, the acidity changes the spectral signal of at least a portion of the sensor material. In certain embodiments, the acidity causes a chemical change or depolymerization of at least a portion of the sensor material. According to certain embodiments, the acidity causes a change in the carrier densities in the single-walled nanostructures.

In certain embodiments, depolymerization of a poly(olefin sulfone) material releases SO₂, which can be transformed to sulfuric acid in the presence of air and moisture. In some cases, sulfuric acid can cause changes in the matrix by reacting with other polymers, redox active additives, and/or acid responsive dyes.

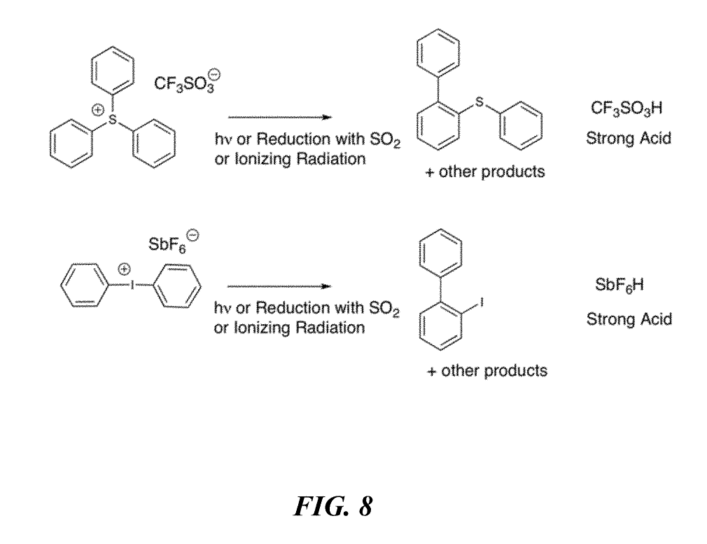

A method for generating an initiator species, such as an acid, either directly or indirectly from a radiation event, is to employ initiators used in chemically amplified lithography. For example, stable cationic complexes may be placed into a polymer matrix, where exposure to light creates a strong acid. FIG. 8 shows examples of various additives that are capable of generating initiator species upon exposure to radiation. Other photoacid generators or photoresist additives may also be used in the context of this invention, where photoexcitation of a cationic acid precursor results in their reduction by electron transfer processes. In the case of the iodine containing photoacid generators, the heavy atoms may help to increase the reactive cross-section.

According to certain embodiments, the compositions and/or device sensor materials may comprise an additional polymer. In certain embodiments, the additional polymer comprises the structure,

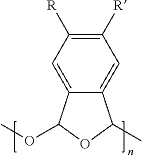

wherein R and R′ can be the same or different and are alkyl, heteroalkyl, alkenyl, heteroalkenyl, alkynyl, heteroalkynyl, aryl, heteroaryl, any of which may be substituted; n is 10 or greater. According to certain embodiments, the additional polymer is capable of undergoing acid catalyzed depolymerization.

In some embodiments, the additional polymer comprises the structure,

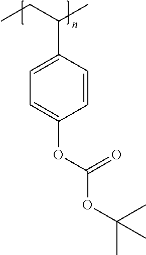

wherein n is 1 or greater. In certain embodiments, the additional polymer is capable of undergoing acid catalyzed reactions to release a phenol.

In some cases, the ionizing radiation may produce a spectral change within the device, wherein observation of a visible change in color may determine the analyte. For example, metal nanoparticles (e.g., bismuth nanoparticles) may be incorporated within the sensor material to create sensors that provide a visual signal to radiation. In these schemes, the small particle sizes may give rise to plasmon absorptions that can give rise to strong colors. In certain other embodiments, the generation of an acid (e.g., an acidic solution) may cause a spectral change (e.g., a visible change) due to a pH sensitive dye, which changes color based on pH.

Quantification of the sensitivity in these devices may be performed by absorbance spectroscopy. The change in a peak and/or trough of the spectrum may be measured, for example, by addition, subtraction, multiplication, or division of the spectra, or by observation of a change in the distance between peaks and/or troughs of the spectra, a change in the shape of the spectra, and/or the like. In some cases, the change in signal may be determined using an analyzer that may compare the signals produced by the device before and after exposure to an analyte. In some cases, the signals may be further processed to determine the analyte. For example, the signal may be filtered, amplified, subject to Fourier transforms, decomposed using wavelet decomposition, and/or the like.

In some cases, the optical change can be a change in emission. Emission changes can result from interactions of dyes with the plurality of single-walled nanostructures. In certain embodiments, emission changes may comprise an increase or decrease in emission intensity. In some embodiments, chemical changes caused by radiation exposure in the sensory materials can also change the emission of dyes. For example, dyes can display different emission colors or intensities as a function of local pH.

Some devices may be fabricated such that two or more different types of ionizing radiations may be determined. In some cases, the sensor material may include a gradient of materials capable of determining a wide range of radiation. That is, the device may comprise components that may specifically interact with various types of ionizing radiations. For example, the sensor material may include a plurality of metal-containing groups, each group having a different cross-section value for interaction with ionizing radiation. In some cases, the device may be fabricated such that it includes at least two different types of species (e.g., metal atoms or nanoparticles), each selected to interact with a specific type of ionizing radiation, such that various changes in the signal(s) produced by the device may be attributed to a particular form of ionizing radiation. The species may differ in chemical structure, size, or other properties. In an illustrative embodiment, the sensor material may comprise both bismuth atoms or nanoparticles, which may enhance the opacity of the sensor material to gamma rays, and gadolinium atoms or nanoparticles, which may enhance the opacity of the sensor material to neutrons. It should be understood that the device may contain any number of additives for determining ionizing radiation.

In another set of embodiments, a system may include an array of individual devices having varying levels of sensitivity to different types of radiation, thereby providing a spectrometer that can identify more than one type of radiation. Array devices can be created, for example, for spectroscopic detection of gamma rays of different energies, and/or for discrimination between thermal and fast neutrons. In a particular embodiment, devices capable of detecting radiation as part of distributed sensor arrays are provided. Distributed arrays can be used to monitor transportation systems, shipping containers, or distributed in other areas of interest. In addition to non-proliferation applications, these devices can have applications in occupational safety and will enable individuals to know immediately if they are being exposed to radiation.

The devices described herein may comprise additional components, such as a signal generator that generates a signal responsive to a change in polymerization characteristic, and a detector component positioned to detect the signal. In one set of embodiments, the device may be a chemiresistor device, wherein the device exhibits changes in electrical resistance upon exposure to an ionizing radiation. Chemiresistors may be advantageous in that the resistance changes can be read-out by a simple, low power and low current circuit. In other embodiments, a device of the present invention may exhibit signals, or changes in signals, that may be determined using Raman spectroscopy, adsorption and/or emission photophysics, ellipsometry, atomic force microscopy, scanning electron microscopy, electrode passivation, and the like.

According to certain embodiments, the device is wearable sensor. In some embodiments, the device is integrated into packaging materials. According to certain embodiments, the device is a wireless radio frequency identification sensor. In some embodiments, the device operative in a passive mode powered wirelessly with no internal power supply in the device.

Methods for determining ionizing radiation are also provided. As used herein, the term “determining” generally refers to the analysis of a species or signal, for example, quantitatively or qualitatively (whether an analyte is present and/or in what amount or concentration), and/or the detection of the presence or absence of the species or signals. “Determining” may also refer to the analysis of an interaction between two or more species or signals, for example, quantitatively or qualitatively, and/or by detecting the presence or absence of the interaction. For example, the method may include the use of a device capable of producing a first, determinable signal (e.g., a reference signal), such as an electrical signal, an optical signal, or the like, in the absence of ionizing radiation. The device may then be exposed to ionizing radiation, wherein the ionizing radiation may interact with one or more components of the device to cause a change in the signal produced by the device. Determination of the change in the signal may then determine the analyte. The signal may, in some cases, provide information relating to the presence, identity, amount, and/or other characteristic of the ionizing radiation. In some embodiments, the change in signal may occur upon interaction between ionizing radiation and at least a portion or component of the device. For example, the ionizing radiation may contact or may permeate an interior portion of the sensor material. In some embodiments, a volumetric or dimensional change (e.g., increase, decrease) of the sensor material may occur upon interaction with an analyte. In some cases, the interaction between the sensor material and the ionizing radiation may comprise a reaction, such as a depolymerization reaction. For example, the method may involve exposure of the device to an environment suspected of containing ionizing radiation, wherein the ionizing radiation, if present, interacts with the polymer material such that at least a portion of the polymer material undergoes a change in a polymerization characteristic, which generates a determinable signal. In some cases, exposure of the device to an environment suspected of containing ionizing radiation, results in a change in the average distance between adjacent nanostructures, which generates a determinable signal. Determination of the signal may then determine the ionizing radiation.

In some embodiments, the device comprises a first electrode and a second electrode in electrochemical communication with the sensor material, such that the determinable signal comprises a change in resistance to current flow between the first and second electrodes. For example, the resistance may decrease upon exposure to ionizing radiation. In some cases, methods described herein may determine an ionizing radiation with relatively high selectivity and/or specificity. For example, the device may comprise a sensor material that is responsive to a particular type of ionizing radiation and is substantially unresponsive to other types of ionizing radiation or is responsive to a lesser degree, such that the change in signal may be attributed to an interaction between the sensor material and the particular type of ionizing radiation. In some cases, the method may involve determination of more than one type of ionizing radiation present within a sample. For example, the interaction between a first type of ionizing radiation and the sensor material may give a first change in the properties (e.g., electrical properties) of the sensor material, while the interaction between a second type of ionizing radiation and the sensor material may give a second, different change in the properties of the sensor material, such that distinguishable changes in signal may be determined for both the first and second types of ionizing radiation.

Devices of the invention may be fabricated using methods described herein, and/or in combination with other methods known to those of ordinary skill in the art. In some embodiments, methods of the invention may advantageously provide the ability to process materials which may otherwise be insoluble and/or difficult to process. For example, the method may allow for the formation of stable dispersions of nanostructures, such that the nanostructures are readily processed in solution. In some cases, the method may involve processing a mixture comprising a plurality of nanostructures (e.g., carbon nanotubes) and a polymer material, or precursor thereof, to form a sensor material as described herein. The mixture may be a solution, a suspension, a dispersion, or the like. In some cases, the polymer material may have a relatively high molecular weight. In some cases, a dispersion of nanostructures may be stable under ambient atmosphere, at room temperature, and/or for long periods of time (e.g., several weeks, months, or years).

As used herein, the term “nanostructure” refers to any chemical structure having at least one dimension on the order of nanometers. In some cases, the nanostructure has an elongated chemical structure having a diameter on the order of nanometers and a length on the order of microns to millimeters, resulting in an aspect ratio greater than 10, 100, 1000, 10,000, or greater. In some cases, the nanostructure may have a diameter less than 1 μm, less than 500 nm, less than 100 nm, 50 nm, less than 25 nm, less than 10 nm, or, in some cases, less than 1 nm. The nanostructure may have a cylindrical or pseudo-cylindrical shape. In some cases, the nanostructure may be a nanotube, such as a carbon nanotube. In some cases, the nanostructure is a nanorod, nanowire, or nanoribbon. In some cases, the nanostructure is a nanoparticle.

As used herein, the term “carbon nanotube” is given its ordinary meaning in the art and refers to a substantially cylindrical molecule, in some cases, comprising a fused network of six-membered aromatic rings. In some cases, carbon nanotubes may resemble a sheet of graphite rolled up into a seamless cylindrical structure. It should be understood that the carbon nanotube may also comprise rings other than six-membered rings. Typically, at least one end of the carbon nanotube may be capped, i.e., with a curved or nonplanar aromatic group. Carbon nanotubes may have a diameter on the order of nanometers and a length on the order of millimeters, resulting in an aspect ratio greater than about 100, greater than about 1000, greater than about 10,000, or greater. The term “carbon nanotube” includes single-walled nanotubes (SWCNTs), multi-walled nanotubes (MWCNTs) (e.g., concentric carbon nanotubes), inorganic derivatives thereof, and the like. In some embodiments, the carbon nanotube is a single-walled carbon nanotube. In some cases, the carbon nanotube is a multi-walled carbon nanotube (e.g., a double-walled carbon nanotube).

The carbon nanotubes may be functionalized or substituted with a wide range of functional groups. Examples of functional groups that carbon nanotubes may be substituted with include peptides, proteins, DNA, RNA, peptide nucleic acids (PNA), metal complexes, ligands for metals, ligands for proteins, antibodies, polarizable aromatics, crown ethers, hydroxyl amines, polymers, initiators for polymerizations, liquid crystals, fluorocarbons, synthetic receptors, and the like. The properties of the carbon-containing molecules may also be tailored based on the substitution of the fused, aromatic network. Those skilled in the art would recognize what types of functional groups would afford a particular, desired property, such as increased solubility, or the ability to determine an analyte. In some embodiments, the substituted carbon nanotube comprises a binding site. In some embodiments, substituted carbon nanotubes may be readily processed in a fluid carrier. That is, dispersions of substituted carbon nanotubes may be formed.

Substituted carbon nanotubes may be synthesized using various methods, including those described in Zhang et al., J. Am. Chem. Soc. 2007, 129 (25), 7714 and/or International Publication No. WO2008/1337791, both of which are incorporated herein by reference in their entirety for all purposes. In other cases, carbon nanotubes can be functionalized by methods described by He and Swager; Chem. Mater. 2017, 28, 8542. It is anticipated that many other functionalization methods can be used including those that connect groups to carbon nanotubes through carbon-nitrogen bonds.

Polymers or polymer materials, as used herein, refer to extended molecular structures comprising a backbone (e.g., non-conjugated backbone, conjugated backbone) which optionally contain pendant side groups, where “backbone” refers to the longest continuous bond pathway of the polymer. In some embodiments, the polymer is substantially non-conjugated or has a non-conjugated backbone. In some embodiments, at least a portion of the polymer is conjugated, i.e. the polymer has at least one portion along which electron density or electronic charge can be conducted, where the electronic charge is referred to as being “delocalized.” A polymer may be “pi-conjugated,” where atoms of the backbone include p-orbitals participating in conjugation and have sufficient overlap with adjacent conjugated p-orbitals. It should be understood that other types of conjugated polymers may be used, such as sigma-conjugated polymers.

In certain non-limiting embodiments, the polymer is poly(olefin sulfone)s.

The polymer can be a homo-polymer or a co-polymer, such as a random co-polymer or a block co-polymer. In one embodiment, the polymer is a block co-polymer. An advantageous feature of block co-polymers is that they may mimic a multi-layer structure, wherein each block may be designed to have different band gap components and, by nature of the chemical structure of a block co-polymer, each band gap component is segregated. As described herein, the band gap and/or selectivity for particular analytes can be achieved by modification or incorporation of different polymer types. The polymer compositions can vary continuously to give a tapered block structure and the polymers can be synthesized by either step growth or chain growth methods.

The number average molecular weight of the polymer may be selected to suit a particular application. As used herein, the term “number average molecular weight (Mn)” is given its ordinary meaning in the art and refers to the total weight of the polymer molecules in a sample, divided by the total number of polymer molecules in a sample. Those of ordinary skill in the art will be able to select methods for determining the number average molecular weight of a polymer, for example, gel permeation chromatography (GPC). In some cases, the GPC may be calibrated vs. polystyrene standards. In some cases, the number average molecular weight of the polymer is at least about 10,000, at least about 20,000, at least about 25,000, at least about 35,000, at least about 50,000, at least about 70,000, at least about 75,000, at least about 100,000, at least about 110,000, at least about 125,000, or greater.

In some embodiments, various components of the device are formed on a substrate. The substrate can comprise a wide variety of materials, as will be appreciated by those in the art, including printed circuit board (PCB) materials. Suitable substrates include, but are not limited to, fiberglass, Teflon, ceramics, glass, silicon, mica, plastic (including acrylics, polystyrene and copolymers of styrene and other materials, polypropylene, polyethylene, polybutylene, polycarbonate, polyurethanes, and derivatives thereof, etc.), GETEK (a blend of polypropylene oxide and fiberglass), and the like. The device may also comprise an insulating material. The insulating material may be arranged between the sensor material and one or more electrodes (e.g., gate electrode) and/or the substrate. In some cases, the insulating material may reduce the mobile ion damage and minimize drift in gas sensor devices and/or may improve physical adhesion of the sensor material to the underlying material or substrate. Examples of suitable insulating materials include, but are not limited to, polysilicate glass, silicon dioxide, silicon nitride, and the like.

As used herein, the term “electrode” or “electrode material” refers to a composition, which, when connected to an electronic device, is able to sense a current or charge and convert it to a signal. An electrode may be comprised of a conductive material or combination of materials such as, for example, metals. Non-limiting examples of suitable metals include gold, copper, silver, platinum, nickel, cadmium, tin, and the like. The electrodes may also be any other metals and/or non-metals known to those of ordinary skill in the art as conductive (e.g. ceramics). The electrodes may be deposited on a surface via vacuum deposition processes (e.g., sputtering and evaporation) or solution deposition (e.g., electroplating or electroless processes). In a specific example, gold electrodes are deposited by sputter-coating.

As used herein, the term “environment” refers to any medium (e.g., solid, liquid, gas) that can be evaluated in accordance with the invention including, such as air or other vapor samples, soil, water, a biological sample, etc. An “environment suspected of containing” a particular component means a sample with respect to which the content of the component is unknown. For example, a gas environment where one or more forms of ionizing radiation may be present, but not known to have the ionizing radiation, defines a sample suspected of containing ionizing radiation.

As used herein, the term “alkyl” is given its ordinary meaning in the art and may include saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has about 30 or fewer carbon atoms in its backbone (e.g., C1-C30 for straight chain, C3-C30 for branched chain), and alternatively, about 20 or fewer. Likewise, cycloalkyls have from about 3 to about 10 carbon atoms in their ring structure, and alternatively about 5, 6 or 7 carbons in the ring structure. In some embodiments, an alkyl group may be a lower alkyl group, wherein a lower alkyl group comprises 10 or fewer carbon atoms in its backbone (e.g., C1-C10 for straight chain lower alkyls).

The term “heteroalkyl” is given its ordinary meaning in the art and refers to alkyl groups as described herein in which one or more atoms is a heteroatom (e.g., oxygen, nitrogen, sulfur, and the like). Examples of heteroalkyl groups include, but are not limited to, alkoxy, poly(ethylene glycol)-, alkyl-substituted amino, tetrahydrofuranyl, piperidinyl, morpholinyl, etc.

The term “aryl” is given its ordinary meaning in the art and refers to single-ring, multiple-ring, or multiple-fused-ring aromatic groups comprising, for example, 5-, 6- and 7-membered ring aromatic groups, all optionally substituted. In some cases, the at least one ring in the aryl group is aromatic. The term “heteroaryl” is given its ordinary meaning in the art and refers to aryl groups as described herein in which one or more atoms is a heteroatom (e.g., oxygen, nitrogen, sulfur, and the like). Examples of aryl and heteroaryl groups include, but are not limited to, phenyl, pyrrolyl, furanyl, thiophenyl, imidazolyl, oxazolyl, thiazolyl, triazolyl, pyrazolyl, pyridinyl, pyrazinyl, pyridazinyl and pyrimidinyl, and the like. It should be understood that, when aryl and heteroaryl groups are used as ligands coordinating a metal center, the aryl and heteroaryl groups may have sufficient ionic character to coordinate the metal center.

The terms “carboxyl group,” “carbonyl group,” and “acyl group” are recognized in the art and can include such moieties as can be represented by the general formula:

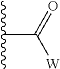

wherein W is H, OH, O-alkyl, O-alkenyl, or a salt thereof. Where W is O-alkyl, the formula represents an “ester.” Where W is OH, the formula represents a “carboxylic acid.” The term “carboxylate” refers to an anionic carboxyl group. In general, where the oxygen atom of the above formula is replaced by sulfur, the formula represents a “thiolcarbonyl” group. Where W is a S-alkyl, the formula represents a “thiolester.” Where W is SH, the formula represents a “thiolcarboxylic acid.” On the other hand, where W is alkyl, the above formula represents a “ketone” group. Where W is hydrogen, the above formula represents an “aldehyde” group.

As used herein, the term “halogen” or “halide” designates —F, —Cl, —Br, or —I.

The term “alkoxy” refers to the group, —O-alkyl.

The term “aryloxy” refers to the group, —O-aryl.

The term “acyloxy” refers to the group, —O-acyl.

The term “arylalkyl”, as used herein, refers to an alkyl group substituted with an aryl group.

The terms “amine” and “amino” are art-recognized and refer to both unsubstituted and substituted amines, e.g., a moiety that can be represented by the general formula: N(R′)(R″)(R′″) wherein R′, R″, and R″ each independently represent a group permitted by the rules of valence.

As used herein, the term “substituted” is contemplated to include all permissible substituents of organic compounds, “permissible” being in the context of the chemical rules of valence known to those of ordinary skill in the art. In some cases, “substituted” may generally refer to replacement of a hydrogen atom with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” group must still comprise the phenyl moiety and cannot be modified by substitution, in this definition, to become, e.g., a cyclohexyl group. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For example, a substituted alkyl group may be CF3. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Examples of substituents include, but are not limited to, alkyl, aryl, arylalkyl, cyclic alkyl, heterocycloalkyl, hydroxy, alkoxy, aryloxy, perhaloalkoxy, arylalkoxy, heteroaryl, heteroaryloxy, heteroarylalkyl, heteroarylalkoxy, azido, amino, halogen, alkylthio, oxo, acylalkyl, carboxy esters, carboxyl, carboxamido, nitro, acyloxy, aminoalkyl, alkylaminoaryl, alkylaryl, alkylaminoalkyl, alkoxyaryl, arylamino, arylalkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like.

The following examples are intended to illustrate certain embodiments of the present invention, but do not exemplify the full scope of the invention.

### Example 1

This example describes the synthesis of poly(olefin sulfone)s (POSs).

For sensor materials, it is critical to isolate nanostructures (e.g. SWNSs) in a non-conductive polymeric matrix. Thus, POSs have been designed and synthesized to effectively disperse, de-bundle, and individualize SWNSs. Standard synthetic conditions of POSs involves bulk polymerization at low temperatures (e.g., 45° C.) with sulfur dioxide serving as both solvent and co-monomer and tert-butyl hydroperoxide as the initiator. The polymerization reaction of the olefin sulfones proceeds in a strictly alternating fashion as a result of the preferred reaction of sulfonyl radicals chain ends having charge transfer interactions with the electron rich olefin monomer(s) in SO₂. The resulting POSs alternating co-polymers, POSs 1-10, are shown in FIG. 2.

To enhance the dispersability of SWNSs, POS 3 was synthesized, which possesses a benzoate substituent, which visibly increases the SWNS dispersibility in DMF presumably as a result of pi-pi-stacking with the nanostructure sidewalls. Moreover, POS 3 has a lower decomposition temperature (T_{decomp}=188° C.), indicating it is more susceptible to degradation as compared to POS 1 and POS 2.

The Lewis basic POS 4 was also targeted based on the fact that poly(4-vinylpyridine) creates exceptionally stable SWNSs dispersions presumably as a result of interactions between the nitrogen lone pairs and the SWNS sidewalls. Additionally, aromatic N-heterocycles can display pi-pi stacking interactions with nanostructures and be functionalized with ions for the creation of diverse expanded materials. The co-polymerization of SO₂ with 4-vinylpyridine or 1-allylimidazole failed, most likely due to the basicity of these monomers and the base-sensitivity of the polymer backbone. However, this functionality was incorporated in a ter-polymerization scheme involving an excess of 1-hexene as co-monomer, yielding poly(1-hexene sulfone)-co-(1-allylimidazole sulfone) (POS 4) with a x/y ratio of 1.0/9.8 in moderate yields of 78%. The addition of 1-hexene as a co-monomer successfully stabilized the polymer up to T_{decomp}=148° C.

As alternative polymer matrices, we explored the synthesis of new amphiphilic POSs 5 and 6. In an alternative wrapping mechanism, these polymers were designed to stabilize SWNSs in polar solutions. In amphiphilic polymer-nanostructure dispersions, coulombic attractions between the polar polymer side chains and solvent as well as the hydrophobic and van der Waals interactions between the polymer surfactant tails and nanostructure surfaces work synergistically to stabilize the solution. Amphiphilic POS 5 materials are produced by ter-polymerization of 1-hexene, di(ethylene glycol) vinyl ether and SO₂ in 59% yield. A second amphiphilic ionic surfactant polymer, POS 6, poly(l-hexene sulfone)-co-(sodium 4-vinylbenzenesulfonate sulfone), was also synthesized with yields of 75%. The successful and simple generation of these POSs 5 and 6 illustrates the facile generation of designer radiation sensitive co-polymers.

The synthesis of POS 7 involves multiple steps and incorporates a pyrene moiety to bind to the surfaces of SWNSs, and a high-atomic number bismuth complex component to increase gamma ray opacity.

### Example 2

This example describes the synthesis of single-walled nanostructures (SWNSs) wrapped with POSs to form POS-SWNS composites.

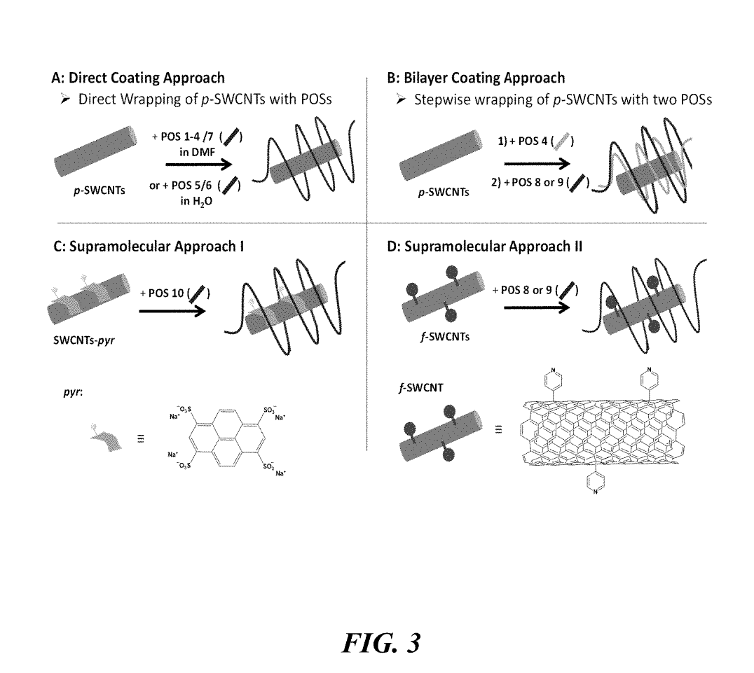

POSs 1-7 were designed to wrap pristine, unfunctionalized SWNSs in solution, and to create isolated thin film network SWNSs. In addition to wrapping of SWNSs with POSs 1-7 (FIG. 3; Approach A), poly(allyl alcohol sulfone) (POS 8), poly(2-allyl hexafluoroisopropanol sulfone) (POS 9), and poly(allylamine hydrochloride sulfone) (POS 10) were designed to display supramolecular interactions with non-covalently and covalently functionalized SWNSs (FIG. 3; Approaches B-D).

Using POS 7 and POS 8 as hydrogen-bonding donor polymers, dispersions of POS 4 pre-wrapped SWNSs (Approach B), and dispersions of covalently pyridyl-functionalized SWNSs (Approach D) were complexed and shown to display additional stability. In addition to the stabilization of SWNSs via noncovalent hydrogen-bonding and hydrophobic interactions, electrostatic interactions in the wrapping of SWNSs were also explored (Approach C). In this layer-by-layer self-assembly approach, pristine SWNSs were first non-covalently pre-functionalized in dispersion with pyrene tetrasulfonate. In a second step, POS 10 was added to wrap around pre-dispersed pyridyl-functionalized SWNSs via coulombic and entropic driven assembly. In these assemblies, the aromatic core serves as an anchor to the sidewalls of the SWNSs via pi-pi stacking interactions to increase the water dispersibility of the system. Noncovalent functionalization procedures are less disruptive to the SWNS electronic structure as compared to a covalent surface functionalization and thereby are expected to have higher intra-nanotube carrier mobilities. The polyanionic pyridyl-functionalized SWNS dispersions are further stabilized by irreversible assembly with POS 10.

All poly(olefin sulfone)s POS 1-10 were characterized by ¹H and ¹³C NMR, gel-permeation chromatography (GPC), Fourier-transform infrared spectroscopy (FT-IR), dynamic light scattering (DLS), and thermogravimetric analysis (TGA). The molecular weights of all polymers were found to range between 17-173 kDa with polydispersities (D) of 1.9-2.5. Table 1 displays the molecular weight data and decomposition temperatures of all poly(olefin sulfone)s investigated herein. A successful non-covalent functionalization of SWNSs using pyrene tetrasulfonate was proven by UV-Vis-NIR absorption spectroscopy. The covalent attachment of pyridyl-units to the SWNS sidewalls was accomplished by means of in-situ diazonium chemistry. This fast and simple functionalization sequence yields functionalized SWNSs as evidenced by Raman microscopy, UV-Vis-NIR spectroscopy, as well as X-ray photoelectron spectroscopy (XPS). The analysis of the D-band intensity relative to the G-band intensity in the Raman spectra provides further evidence of successful covalent surface functionalization.

TABLE 1
Characterization of synthesized polymers POS 1-10 and their CNT dispersion efficiencies.

| | | Polymer | | | | | | |
|---|---|---|---|---|---|---|---|---|
| | | Characterization | | | CNT dispersion | | | |
| | | Mₙ | | T_{Decomp} | | | | Dispersion |
| Entry | Polymer | (kDa) | Ð | (° C.) | CNT | approach | solvent | Efficiency^{a} (%) |
| 1 | POS 1 | 84 | 2.3 | 246 | SWCNT | A | DMF | 2.4 |
| 2 | POS 2 | 26 | 2.2 | 232 | SWCNT | A | DMF | 2.5 |
| 3 | POS 3 | 53 | 2.2 | 188 | SWCNT | A | DMF | 4.7 |
| 4 | POS 4 | 60 | 2.3 | 148 | SWCNT | A | DMF | 7.2 |
| 5 | POS 5 | 49 | 2.5 | 156 | SWCNT | A | H₂O | 26.6 |
| 6 | POS 6 | | | 262 | SWCNT | A | H₂O | 31.3 |
| 7 | POS 7 | 17 | 2.1 | 197 | SWCNT | A | DMF | 7.1 |
| 8 | POS 8 | | | 273 | SWCNT | A | DMF | 1.4 |
| 9 | POS 9 | 173 | 2.0 | 281 | SWCNT | A | DMF | 3.6 |
| 10 | POS 10 | 37 | 1.9 | 182 | SWCNT | A | H₂O | 0.6 |
| 11 | POS 4 & 8 | — | — | — | SWCNT | B | DMF | 15.8 |
| 12 | POS 4 & 9 | — | — | — | SWCNT | B | DMF | 19.0 |
| 13 | POS 10 | — | — | — | SWCNT- | C | H₂O | 11.7 |
| | | | | | pyr | | | |
| 14 | POS 8 | — | — | — | f- | D | DMF | 16.6 |
| | | | | | SWCNT | | | |
| 15 | POS 9 | — | — | — | f- | D | DMF | 18.8 |
| | | | | | SWCNT | | | |

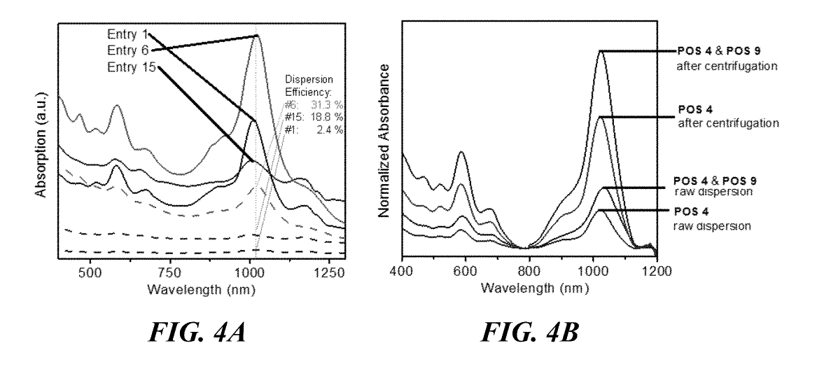

UV-Vis-NIR measurements provided insight into the SWNS dispersion efficiencies of the synthesized polymers using the different coating Approaches A-D. The potential of POSs 1-10 to solubilize carbon nanotubes was determined by sonicating 0.1 wt. % SWNS-dispersions in the presence of excess of poly(olefin sulfone) (10 wt. eq.) for one hour at room temperature, followed by centrifugation (14.00 rpm) to remove large particulates that were not efficiently solubilized. The ratio of the absorbance of the coated SWNSs at wavelengths of ˜1000 nm before and after the centrifugation step (FIG. 4A and FIG. 4B) represents the percent dispersion efficiencies, as shown in Table 1. As the performance of the radiation sensor devices directly depends on the individualization of the individual SWNSs in the POS-SWNS composite active layer, the generation of the stable SWNS dispersions is crucial. Not surprisingly, aliphatic POSs 1 and 2 did not show pronounced interactions with the SWNSs. The UV-Vis-NIR spectra before and after centrifugation of a solution of SWNSs and POS 1 in DMF are displayed in FIG. 4A. Alternatively, POSs 3 and 4 resulted in an increased dispersion efficiency of 4.7% and 7.2%, respectively. The isolated supernatant from the centrifuged suspensions contained well-dispersed POS-SWNS composites that resist re-bundling and aggregation over extended periods (>5 days). In addition to the dispersion efficiency, confirmation of SWNS individualization is necessary to evaluate the quality of the dispersions. FIG. 4B displays normalized absorbance spectra of a POS 4-SWNS composite dispersion before and after centrifugation. The peaks, arising from the SWNS optical transitions, were significantly sharper and more intense relative to the base absorbance background upon which the spectra are normalized. Amphiphilic POSs 5 and 6 showed the most stable dispersions of 26.6% and 31.3%, respectively. This was attributed to a solubilizing effect of the polar polymer side chains and the hydrophobically enhanced and van der Waals association between the alkyl moieties and the CNT surfaces. Beyond providing information about the dispersion efficiency and individualization, the absorbance spectra of POS 9-functionalized SWNS demonstrates further evidence for a successful covalent surface functionalization. Individualized pristine SWNS samples typically show pronounced optical transitions, arising from the van Hove singularities. These features are reduced by the covalent attachment of pyridyl-groups and the well-dispersed supernatant in DMF of POS 9-functionalized SWNS was characterized by a reduction of defined inter-band transitions (FIG. 4A).

### Example 3

This example describes devices comprising POS-SWNS composites that readily depolymerize when exposed to ionizing radiation.

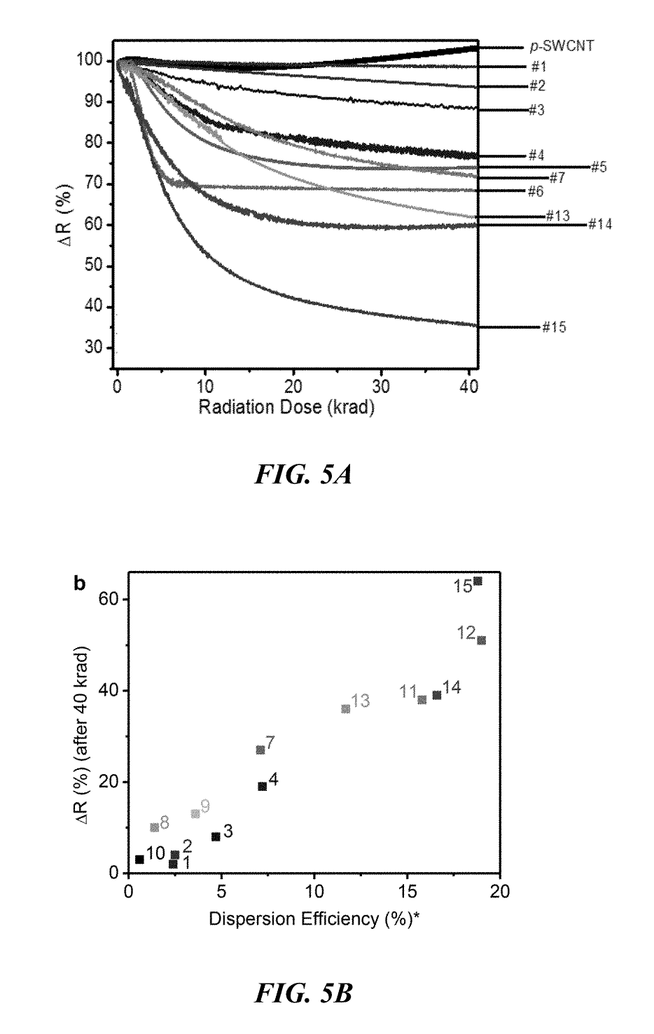

Sensor fabrication using POS-SWNS composites was performed by spray-coating onto glass substrates. A shadow mask was used to selectively deposit POS-SWNS composite dispersions between Au electrodes separated by 1.0 mm. The glass-electrode substrates were heated on a hot plate at 90° C. for rapid solvent evaporation to quickly fix the SWNSs in a random individualized networks. The spray-coating was adjusted such that the deposited POS-SWNS composite had a resistance of R₀ ˜10 kΩ as measured by a multimeter. Sensor testing was performed using a Gammacell irradiator with a 60Co source. By connecting the chemiresistive device via wires to a digital multimeter, real-time dosimetric read-outs with gamme-ray irradiation were observed (FIG. 5). In order to compare the maximum performance of the different composites, the devices were exposed to 40 krad. The resistance of all POS-SWNS composites that were well dispersed rapidly decreased exponentially until saturation was reached. As expected, the composites prepared with POSs 1 and 2 did not respond to gamma irradiation. In general, the performance of the POS-SWNS composites correlates with their dispersion efficiencies. Other factors, including the solvent, the intrinsic POS stability, as well as the type of SWNS (pristine vs. functionalized) also influence the device performance. In devices prepared with amphiphilic POSs 5 and 6 spray coated from H₂O, a rapid onset of the resistance decrease was observed. In control devices prepared from polymer free SWNS dispersions, slight resistance increases at 40 krad were observed, whereas all other devices from POS-SWNS composites resulted in resistance decreases. POS 9-functionalized SWNSs displayed the highest response to gamma rays with a resistance decrease ΔR=R′/R₀ of up to −62% at 40 krad. FIG. 5A shows real-time resistance changes of selected poly(olefin sulfone)-SWNT composites when exposed to gamma ray radiation, and FIG. 5B shows sensitivity to gamma rays of SWNT-POS composites deposited from DMF as a function of the dispersion efficiency. The ratio of the optical absorbance of the coated SWNTs at wavelength 1000 nm (targeting the absorption of the 6,5-SWNT majority species) before and after centrifugation represents the dispersion efficiency.

### Example 4

This example describes the incorporation of high atomic number elements into the POS-SWNS composites.

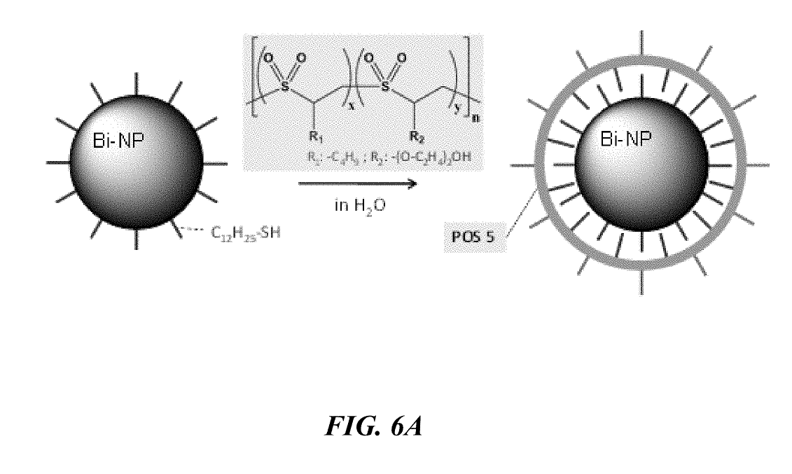

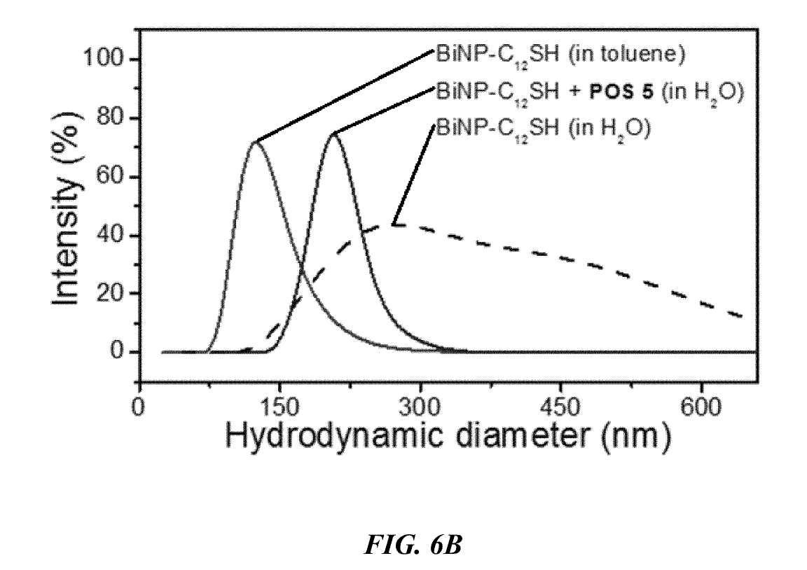

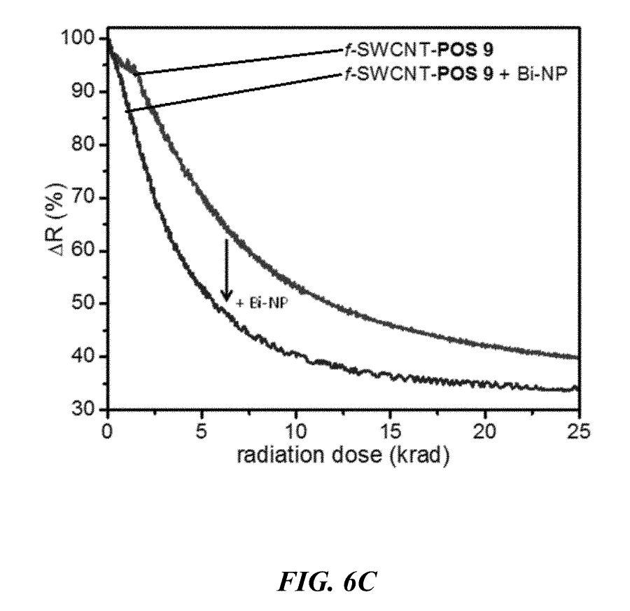

The opacity of materials to gamma rays increases with increasing atomic number. Therefore, it was anticipated that integration of high atomic number elements into the polymer matrix would increase the gamma ray cross-section values of the active layer and lead to higher sensitivity of the devices. Bismuth-nanoparticles were targeted as additional components for the polymer matrices. To accomplish this, dodecanethiol-functionalized bismuth-nanoparticles were synthesized. To ensure uniform dispersions with the lead composition, POS 9-functionalized-SWNS, the bismuth-nanoparticles were then treated with POS 5 to form core shell structures as outlined in FIGS. 6A and 6B. The addition of the bismuth-nanoparticles to the POS-SWNS composite provides some resistance decrease ΔR relative to similar thickness metal-free films, however the sensitivity of the devices increases significantly with this addition. The bismuth-nanoparticles augmented version of POS 9-functionalized-SWNS showed a 50% greater resistance loss at a 5 krad gamma ray dose (FIG. 6C). This simple admixing of high atomic number nanoparticle components represents a facile and pragmatic approach for the generation of POS-SWNS composite materials with a high opacity towards gamma ray irradiation with greatly minimized synthetic effort.

### Example 5

The following example describes the performance of POS-SWNS composites as gamma ray dosimeters in a commercial capacitive platform.

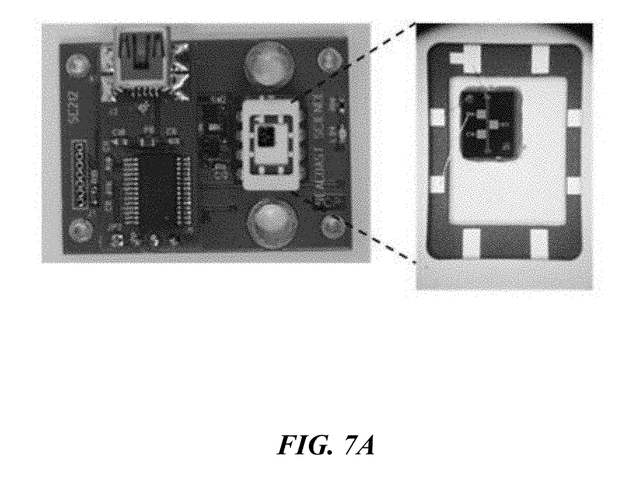

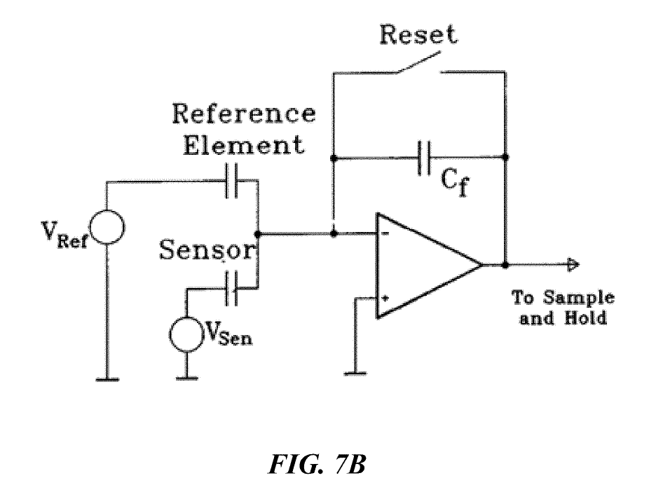

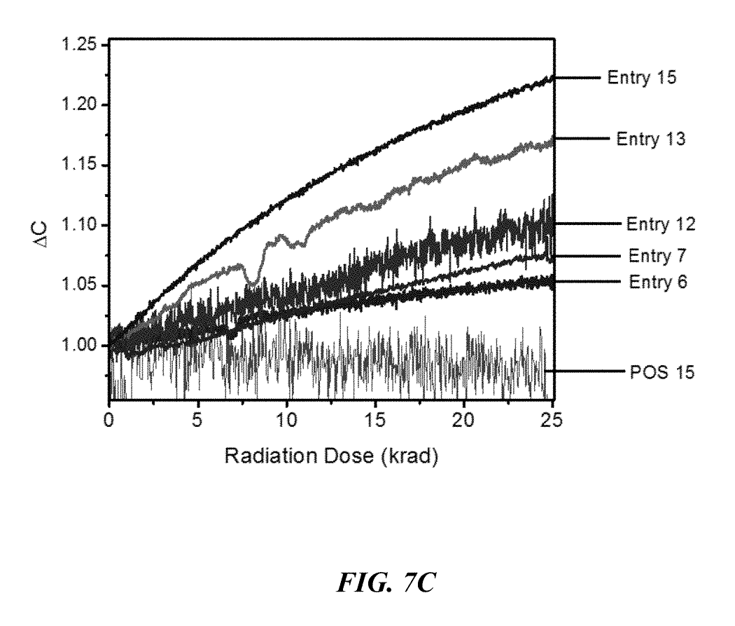

The performance of the POS-SWCNT composites as gamma ray dosimeters in a commercial capacitive platform was explored. The POS-SWCNT composite functions as a dielectric material in a miniaturized capacitive sensor equipped with three individual parallel-plate sensing capacitors with a fixed gap (0.75 micrometers. The devices were coated by dropcasting the POS-SWNS dispersions onto the sensor platform. In contrast to resistive devices, the SWNSs need not be transformed into a state with macroscopic conductivity. The circuit operates by measuring the electrode charging that occurs when the sensor bias is switched to drive the sensor capacitor between charging and discharging (FIG. 7). The sensor bias was switched using a square-wave voltage pulse at a kilohertz frequency (kHz). As the capacitance strongly depends on the dielectric constant, base values were obtained for the pure polymers, without SWNSs. FIG. 7C displays the real-time performance of selected POS-SWNS composites in capacitive sensors. The signal-to-noise ratio of devices coated with pure POSs was high and obstructed clear dosimetric determination of irradiation results. Devices coated with POS-SWNS composites resulted in significantly better signal-to-noise ratios that closely correlated with the dispersion efficiency. As a result, a smooth increase of the capacitance signal ΔC=C′/C₀ was observed for devices. In agreement with the resistive performance of POS 9-functionalized SWNSs, this composite also most sensitively responded to a gamma irradiation in the capacitive devices, resulting in a maximum response of ΔC=+40% at radiation doses of >40 krad. The ease of fabrication and low power consumption of these small and inexpensive sensor platforms combined with the highly appealing sensitivity parameters of the newly synthesized polymer matrices further demonstrates the potential of poly(olefin sulfone)-single-walled nanostructure composites to serve as a new transduction materials for in gamma ray dosimeters. According to certain embodiments, FIG. 7A shows an image of a capacitive device. FIG. 7B shows, in accordance with certain embodiments, a scheme of an electric circuit. FIG. 7C shows, according to certain embodiments, real-time performance of selected poly(olefin sulfone)-SWNT composites to gamma radiation in the capacitive devices.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition for determining ionizing radiation, comprising:
a plurality of functionalized single-walled nanostructures; and
a polymer material integrally connected to at least a portion of the functionalized single-walled nanostructures,
wherein at least a portion of the polymer material undergoes a change in polymerization characteristic upon exposure of the device to radiation.

2. The composition of claim 1, wherein the plurality of functionalized single-walled nanostructures comprise:
a) single-walled carbon nanotubes; and/or
b) graphene.

3. (canceled)

4. The composition of claim 1, wherein the connection between the polymer material and the plurality of functionalized single-walled nanostructures is made by:
a) a covalent bond; and/or
b) a hydrogen bond; or
c) a non-covalent interaction.

5-6. (canceled)

7. The composition of claim 1, wherein the functionalization of the single-walled carbon nanostructure is designed to:
a) create enhanced interactions with the polymer material; and/or
b) interact with Brønsted acids.

8. The composition of claim 7, wherein the enhanced interaction is:
a) hydrogen bonding; and/or
b) electrostatic.

9-10. (canceled)

11. The composition of claim 1, wherein the composition comprises nanoparticles with high atomic number capable of increasing the opacity to ionizing radiation.

12. The composition of claim 11, wherein the nanoparticles comprise:
a) bismuth; and/or
b) gadolinium.

13. (canceled)

14. The composition of claim 1, wherein the nanoparticles:
a) have an intrinsic conductivity; and/or
b) are functionalized with an organic material.

15. (canceled)

16. A device for determining ionizing radiation, comprising:
a sensor material comprising a plurality of functionalized single-walled nanostructures and a polymer material integrally connected to at least a portion of the functionalized single-walled nanostructures, wherein at least a portion of the polymer material undergoes a change in polymerization characteristic upon exposure of the device to radiation; and
a signal generator that generates a signal response to a change in polymerization characteristic, indicative of ionizing radiation.

17. The device of claim 16, further comprising a first electrode and a second electrode, wherein the sensor material is in electrochemical communication with the first electrode and the second electrode, and the signal generator is responsive to a change in resistance and/or capacitance associated with a circuit including the first electrode and the second electrode as affected by the sensor material.

18. The device of claim 16, wherein the device is:
a) a wearable sensor; or
b) integrated into packaging materials.

19. (canceled)

20. The device of claim 16, wherein the change in polymerization characteristic comprises depolymerization of at least a portion of the polymer material.

21. The device of claim 16, wherein the polymer material comprises a poly(olefin sulfone).

22. The device of claim 16, wherein the signal generator generates:
a) a signal response due to a spectral change, optionally wherein the spectral change is a visible change; and/or
b) a change in the resistivity; and/or
c) a change in the capacitance.

23-25. (canceled)

26. The device of claim 16, wherein the device is a wireless radio frequency identification sensor, optionally wherein the device operates in a passive mode powered wirelessly with no internal power supply in the device.

27. (canceled)

28. The device of claim 16, further comprising nanoparticles with high atomic number capable of increasing the opacity to ionizing radiation.

29. The device of claim 28, wherein the nanoparticles:
a) comprise a non-radioactive element responsive to radiation; and/or
b) are coated with an organic material to increase the signal response of the device, optionally wherein the organic material is sensitive to ionizing radiation.

30-31. (canceled)

32. The device of claim 16, wherein the plurality of functionalized single-walled nanostructures are:
a) covalently functionalized; or
b) non-covalently functionalized.

33. (canceled)

34. The device of claim 32, wherein the plurality of functionalized single-walled nanostructures are covalently functionalized with:
a) Lewis or Brønsead basic moieties; and/or
b) pyridyl moieties.

35. (canceled)

36. The device of claim 32, wherein the single-walled nanostructures are functionalized using:
a) carbon-carbon bonds; and/or
b) carbon-nitrogen bond; and/or
c) non-covalent bonds.

37-38. (canceled)

39. A composition for determining ionizing radiation, comprising:
a plurality of nanostructures; and
a polymer material integrally connected to at least a portion of the nanostructures, wherein the polymer material comprises a poly(olefin sulfone) comprising the structure,
wherein: 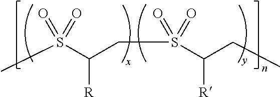
R and R′ can be the same or different and are alkyl, heteroalkyl, alkenyl, heteroalkenyl, alkynyl, heteroalkynyl, aryl, heteroaryl, any of which may be substituted; and x, y, and n is 1 or greater.

40. The composition of claim 39, wherein at least a portion of the polymer material undergoes a change in polymerization characteristic upon exposure to ionizing radiation.

41. The composition as in claim 39, comprising an additional polymer comprising the structure:
a) 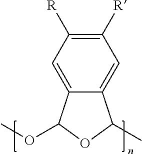
wherein:
R and R′ can be the same or different and are alkyl, heteroalkyl, alkenyl, heteroalkenyl, alkynyl, heteroalkynyl, aryl, heteroaryl, any of which may be substituted; n is 10 or greater; and
wherein the additional polymer is capable of undergoing acid catalyzed depolymerization; and/or
b) 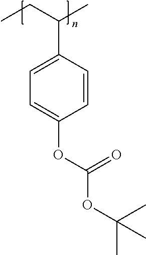
wherein n is 1 or greater; and
wherein the additional polymer is capable of undergoing acid catalyzed reactions to release a phenol.

42. (canceled)

43. A method for determining ionizing radiation, comprising:
exposing a device comprising a sensor material comprising a plurality of functionalized single-walled nanostructures and a polymer material integrally connected to at least a portion of the plurality of functionalized single-walled nanostructures to an environment suspected of containing ionizing radiation, wherein the ionizing radiation, if present, interacts with the polymer material such that at least a portion of the polymer material undergoes a change in polymerization characteristic, thereby generating a determinable signal; and
determining the signal.

44. The method of claim 43, wherein the device further comprises a first electrode and a second electrode in electrochemical communication with the sensor material.

45. The method of claim 44, wherein the determinable signal comprises a change in resistance and/or capacitance associated with a circuit including the first electrode and the second electrode.

46. The method of claim 43, wherein the polymer material comprises a poly(olefin sulfone).

47. The method of claim 46, wherein exposure to ionizing radiation:
a) results in depolymerization of the poly(olefin sulfone) to produce sulfur dioxide and an olefin species; and/or
b) produces an acidity that causes additional changes in the material.

48. (canceled)

49. The method of claim 47, wherein the acidity:
a) changes the spectral signals of a molecule; and/or
b) causes a chemical change or depolymerization of an additional material in the device; and/or
c) causes a change in the carrier densities in the single walled nanostructure.

50-51. (canceled)

52. The method of claim 43, wherein the determinable signal comprises a spectral change, optionally wherein the spectral chance is a visible change.

53. (canceled)

54. A method for determining ionizing radiation, comprising:
exposing a device comprising a sensor material comprising a plurality of nanostructures and a polymer material integrally connected to at least a portion of the plurality of nanostructures to an environment suspected of containing ionizing radiation, wherein the ionizing radiation, if present, interacts with the polymer material such that at least a portion of the polymer material undergoes a change in polymerization characteristic, thereby generating a determinable signal; and
determining the signal,
wherein the determinable signal comprises at least a 10% decrease in resistance upon exposure to no more than a 40 krad dose of radiation.

55. The method of claim 54, wherein the determinable signal comprises a 60% decrease in resistance upon exposure to no more than a 40 krad dose of radiation.
